(19) United States
(12) Patent Application Publication
(10) Pub. No.: US 2015/0007943 A1
(43) Pub. Date: Jan. 8, 2015

(54) LABEL, AND AN APPARATUS AND A METHOD FOR PROVIDING A LABEL

(71) Applicant: UPM RAFLATAC OY, Tampere (FI)

(72) Inventor: Ted Hoerig, Strongsville, OH (US)

(21) Appl. No.: 13/936,447

(22) Filed: Jul. 8, 2013

(51) Int. Cl. B65C 9/30; G09F 3/02

(52) U.S. Cl. CPC B65C 9/30; G09F 3/02; G09F 2003/0201; G09F 2003/023
USPC 156/390; 428/41.8; 428/41.3

(57) ABSTRACT

A printable laminate label and a printed self-adhesive laminate label woundable to a roll. An apparatus for providing a linerless label and a method for providing a linerless label. A label according to an embodiment includes a face stock, an adhesive layer and a release liner. The release liner is releasably attached to a surface of the adhesive layer and an opposing surface of the adhesive layer is attached to a release layer. The release layer is attached to a surface of the face stock, and an opposing surface of the face stock comprises a printable surface. The adhesive layer is detachable from the release layer attached to the surface of the face stock and attachable on a printed surface of the face stock.

### FIELD OF THE APPLICATION

The application concerns a printable label and a printed self-adhesive label woundable to a roll. Further the application concerns an apparatus for providing a label and a method for providing a label.

### BACKGROUND OF THE APPLICATION

Labels typically contain information printed on their top surface. An opposing surface of the label comprises adhesive via which the label is attached to containers, items, articles or goods.

A label stock comprising a face stock, an adhesive and possible other layers, like a release liner, is provided to a printer press for printing. A label stock in wound to a roll for transportation and storage. Once printed, the label stock is wound up again and transported to a separate site for attaching labels to consumer goods.

### SUMMARY

It is an aim of the embodiments to provide a printable label for providing a printed self-adhesive label woundable to a roll.

A label according to an embodiment comprises a face stock, an adhesive layer and a release liner. The release liner is releasably attached to a surface of the adhesive layer and an opposing surface of the adhesive layer is attached to a release layer. The release layer is attached to a surface of the face stock, and an opposing surface of the face stock comprises a printable surface. The adhesive layer is detachable from the release layer, which is attached to the surface of the face stock, and the adhesive layer is attachable on a printed surface of the face stock.

An apparatus according to an embodiment comprises a roll arranged to unwind a wounded label stock, wherein the label stock comprises a face stock, an adhesive layer and a release liner. The release liner is releasably attached to a surface of the adhesive layer and an opposing surface of the adhesive layer is attached to a release layer. The release layer is attached to a surface of the face stock, and an opposing surface of the face stock comprises a printable surface. The apparatus according to an embodiment further comprises a printer unit arranged to print the printable surface of the face stock; a delaminate unit arranged to delaminate the adhesive layer from the release layer, which is attached to the surface of the face stock, and a laminate unit arranged to attach the adhesive layer on a printed surface of the face stock.

A method for providing a self-wounded label stock according to an embodiment comprises providing a roll of printable label stock, wherein the label stock comprises a face stock, an adhesive layer and a release liner. The release liner is releasably attached to a surface of the adhesive layer, and an opposing surface of the adhesive layer is attached to a release layer. The release layer is attached to a surface of the face stock, and an opposing surface of the face stock comprises a printable surface. The method further comprises printing on the printable surface, detaching the adhesive layer from the release liner, and attaching the adhesive layer on a printed surface.

A label according to an embodiment comprises a face stock, a print layer overlying the face stock, and an adhesive layer underlying the face stock, wherein the adhesive layer is arranged to be detachable from the face stock and attachable onto the print layer. The print layer may be arranged to overlie a surface of the face stock, and the adhesive layer detached from the opposing surface of the face stock may be attached onto the print layer.

A label according to an embodiment comprises a release layer arranged to overlie a surface of the face stock, wherein the release layer is arranged next to the adhesive layer on top of the printed surface of the face stock, when the label is self-wound to a roll.

### DESCRIPTION OF THE DRAWINGS

The following drawings are simplified illustrations of the embodiments. The drawings are not in scale.

FIGS. 1-5 illustrate a label according to an embodiment of the invention.

FIG. 6 illustrates an apparatus according to an embodiment of the invention.

FIG. 7 illustrates a method according to an embodiment of the invention.

### DETAILED DESCRIPTION OF THE EMBODIMENTS

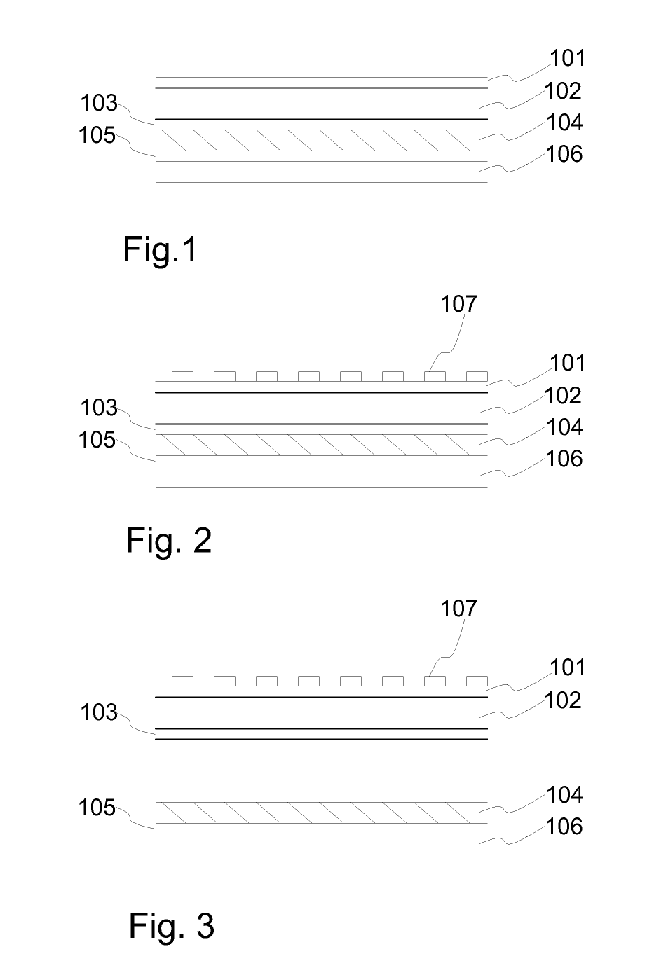

FIG. 1 illustrates a label according to an embodiment of the invention. The label of FIG. 1 comprises a face stock 102 and a top coat 101 on a top surface of the face stock 102. On an opposing surface of the face stock 102 is arranged to overlie an adhesive layer 104. A release layer 103 is arranged between the adhesive layer 104 and the face stock 102. A release liner 106 is arranged to overlie on a surface of the adhesive layer 103, opposing the surface arranged to underlie the face stock 102. A release layer 105 may be laminated on a surface of the release liner 106.

Overlying/underlying refers to an arrangement of a layer in relation to another layer. Overlaying/underlying refers to an arrangement, where a layer partially or completely overlies/underlies another layer. The overlying/underlying layers may be in contact with each other. The overlying/underlying layers are not necessarily in contact with each other, but one or more additional layers may be arranged between the overlying layers.

A label according to embodiments comprises thickness of 5-200 μm, preferably 25-100 μm. The label may be transparent or clear. From the optical point of view, high transparency of the labels may be preferred. Transparent labels are substantially transparent to visible light. Transparent no-label look appearance of the label is a desired property, for example, in applications where the objects beneath the label should be visible through the label. The haze level of a transparent label according to embodiments should be lower than 35%, preferably equal to or lower than 25% or lower than 10%, according to the standard ASTM D1003. According to embodiments the haze of a clear face stock 102 of a label is between 2 and 35% prior to possible printing and over-coating. During possible printing and/or over-coating the haze of the film is reduced. The haze of an over-coated film may be lower than 10%, for example 2-8%. Haze is tested according to standard ASTM D1003. Higher haze values may have positive effect on handling the film before and during printing and subsequent over-coating steps.

A face stock 102 may comprise thickness of 5-60 μm, preferably 10-50 μm. The face stock 102 may comprise a monolayer film or a multilayer film. The face stock 102 may be extruded, coextruded or laminated, for example. Face stock 102 may comprise polymer. Polymeric face stock may comprise or be made of a plastic material based on polyethylene terephthalate (PET), polyvinyl chloride (PVC), polyvinyl fluoride, polystyrene (PS), polypropylene (PP), polyethylene (PE), or polyolefin, for example.

A release liner 106 may comprise plastic, paper or silicone. When clear labels are produced at high speed, a filmic liner may be preferred. This is, at least partly, due to strength and durability of the filmic liner. The filmic liner may be most compatible with the used face stock material. Compatibility of the materials may have effect on providing similar and/or stable properties during production of the label web and/or during printing, driving, handling, processing and/or cutting labels.

The adhesive layer 104 enables providing a self-adhesive label and attachment of the label to a consumer good, article, item or container. The adhesive layer 104 may comprise solvent-based adhesive, for example polyurethane. The adhesive layer 104 may comprise dry content of adhesive of 2-4 g/m². Suitable adhesives comprise, for example, pressure-sensitive adhesives (PSA), activated adhesives, hot melt adhesives. Amount of the adhesive layer is 5-30 gsm, or preferably less than 15 gsm; or more preferably less than 10 gsm. The adhesive layer may comprise a pressure sensitive adhesive (PSA), such as acrylic based adhesives, natural or synthetic rubber containing elastomers, or blended adhesives.

The release layer 103 between the face stock and the adhesive layer may comprise silicon. The release layer 105 between the release liner and the adhesive layer may comprise silicon. The release layers 103, 105 comprise a release value. According to an embodiment the release layer 103 between the face stock and the adhesive layer comprises low release silicon, or silicon of a low release value. Low release or low release value corresponds to low force required to detach the release layer form the layer next to it. In other words relatively low force is required to detach the release layer 103 from the adhesive layer 104. According to another embodiments the release layer 105 between the release liner and the adhesive layer comprises high release silicon, or silicon of a high release value. High release or high release value corresponds to a high force required to detach the release layer form the layer next to it. In other words relatively high force is required to detach the release layer 105 from the adhesive layer 104. The release force may be dependent on many factors, for example neighbouring surfaces or materials, humidity, temperature and alike. According to at least some/all embodiments the release layer 103 between the release liner and the adhesive layer comprises lower release value than the release layer 105 between the release liner and the adhesive layer. In practice, less force is required to detach the release layer 103 from the adhesive layer 104 compared to the force required to detach the release layer 105 from the adhesive layer 104. Release values of the release layers 103, 105 may have relation of 1:3. Release values of the release layers 103, 105 may have relation from 1:2 to 1:5, preferably from 1:2.5 to 1:4. Release level is measured, for example, at 2 inches (5 mm) width, 300 inches (762 mm) per minute at 180 degree peel.

The face stock 102 may comprise one or more coating 101 on a printable surface. The coating 101 on a top surface of the face stock 102 may be called a top coat. The top coat 101 may enhance adhesion of a printing ink or an adhesive to the face stock 102 and/or provide protection against external conditions, like abrasion and/or moisture. The top coat 101 may be ink-receptive and/or adhesive-receptive. The top coat 101 may comprise, for example, polyolefin, polyester or a primer, like acrylic primer. The top coat 101 may comprise polyethylene terephthalate (PET). The top coat 101 may comprise thickness of 0.1 to 2.0 grams per square meter (gsm).

According to an embodiment a surface treatment is made to a printable surface of a label. An external surface of the FIG. 1 may be the top coat 101 or, in case there is no top coat layer 101, the face stock 102. The surface receiving a print may be treated. Surface treatment may comprise corona, flame or plasma treatment, for example. Surface treatment causes increase in a surface energy of the treated surface. Surface treatment with high voltage discharge modifies only the surface without affecting internal properties of the treated material. Surface energy has effect on how well a liquid, like ink, wets the surface. Surface energy has effect on printability of a surface. Example surface energy values for some materials are approximately less than 20 mN/m for silicone and polytetrafluoroethylene (PTFE), 30 mN/m for polypropylene (PP), 32 mN/m for polyethylene (PE) or cross linked polyethylene (XLPE), 34 mN/m for polystyrene (PS), polycarbonate (PC), acrylonitrile butadiene styrene (ABS) and polyurethane (PUR). Surface energy of a treated surface may be at least 38 mN/m. Example ranges for a surface energy of a printable surface for adhesion with UV ink are 48-56 mN/m for UV ink, 50-56 mN/m for water based ink, 46-52 mN/m for coatings, 48-56 mN/m for water based glue, 44-59 mN/m for UV glue. A surface treatment causes temporal changes to the treated surface. A treated surface shall interface with coating, ink, adhesive or another material after the treatment, preferably before any storage or transportation. Effect(s) of the surface treatment may decrease over time. While time passes after a surface treatment, the effects of the treatment gradually decrease till those become void. Once the treated surface has been interfaced with coating, ink, adhesive or another material, the bond becomes permanent.

FIG. 2 illustrates a label according to an embodiment of the invention, wherein a print layer 107 is provided on the printable top coat 101 of the face stock 102. The print layer 107 may be printed on the top coat 101 or on the topmost or external surface of the face stock 102. The print layer 107 may comprise printed information in any form, like letters, numbers, images or codes. Used printing method may be flexographic, screen printing, offset, letter press, thermal transfer, or any other suitable printing method compatible with used label. The print layer 107 comprises ink. The inks used may comprise water-based, solvent-based or radiation-curable inks. Ink primers or ink adhesion promoter may be applied to a surface before application of the ink. A printable surface may be coated or surface treated in order to improve adhesion of the ink to a layer. This has positive effect on printability and print quality. In an embodiment, a print layer 107 is a polymeric ink layer. For example a cross-linked ink may be screen printed onto a printable layer of a label. The print layer 107 may be provided on a top coat 101, which comprises good printing properties. Choice of printing technique and/or inks used depends on printable layer, among others. Print layer may comprise character(s), symbol(s) or graphics, applied in mono- or multicolours.

Conventionally, an additional layer may be provided on top of the printing layer 107 of the label of FIG. 2. The additional layer is typically a transparent protective layer, such as a lacquer or a laminated film layer. Also other kind of layers are suitable and may be used alternatively or additionally. The topmost layer of the label may protect the print 107 and/or has effect on appearance of the label and/or has effect on label's durability on external influences, like wear, humidity, sunlight, UV-radiation, cold and so on. Attaching an additional layer on top of a printed surface of a label web requires an extra coating or laminating step after printing. It is typical that a label stock provider transmits a label web to a printing press, where printing is applied on a surface of the label web. The printed label web is then wound onto a roll for transferring. The roll of printed label web is transmitted back to premises of the label stock provider, where an additional layer is laminated on top of the printed layer. In addition to the extra process step of over-coating, the label stock is transferred back and forth, wound (or rolled) for transferring, and handled and/or treated in separate locations by different providers. Additional layer is needed, as well as an equipment for laminating or attaching it. This is time consuming and induces costs.

At least some/all embodiments of the present invention have effect of avoiding need of a separate layer or a separate step of providing a layer on top of a print layer. According to embodiments no extra over-coating at label provider's premises is required.

FIG. 3 illustrates a label according to an embodiment of the invention, wherein the adhesive layer 104 and the release liner 106 are detached or delaminated from the release layer 103, and the printed 107 face stock 102 (with optional top coat 101). Top coat 101 is illustrated as a top surface of the face stock 102 in FIG. 3. The release value of the release layer 103 between the face stock 102 and the adhesive layer 104 is low compared to release value of the release layer 105 between the release liner 106 and the adhesive layer 104. The release value has effect on detachability. The release layer having a certain release value may enable the adhesive layer 104 being detachable from the release layer 103. In FIG. 3 the adhesive layer 104 is delaminated from the face stock 102, or from the release layer 103 attached to, or as in the FIG. 3 underlying, the face stock 102.

In the FIG. 3 the face stock 102, the top coat 101, the print layer 107 and the release layer 103 form an integral unit. The top coat 101 is arranged to overlie the face stock 102, the print layer 107 is arranged to overlie the top coat 101, the release layer 103 is arranged to underlie the face stock 102. The adhesive layer 104, the release layer 105 and the release liner 106 form another integral unit. The release layer 105 is arranged to underlie the adhesive layer 104. The release liner 106 is arrange d to underlie the release layer 105. The two integral units are separate from each other in the FIG. 3. The adhesive layer 104, the release layer 105 and the release liner 106 have been delaminated from the face stock 102 and/or from layers of the integral unit including the face stock 102.

The delaminated adhesive layer 104, or the delaminated integral unit including the adhesive layer 104, is transferrable. The adhesive layer 104 is attachable onto the printed surface 107. In an embodiment the delaminated adhesive layer 104 (or the integral unit including it) may be transferred through series of rollers and guided so that it is attachable onto the print layer 107, or on the printed surface 107 of the face stock 102. The adhesive layer 104 is turned over after delamination and before lamination onto a print. The overturned integral unit including the adhesive layer 104 may be attached on top of the print layer 107 so that the adhesive layer 104 is arranged to overlie the print layer 107. The release liner 106 may overlie the adhesive layer 104. According to an embodiment an adhesive layer 104 is arranged next to a print layer 107. The adhesive 104 layer may be arranged between the print layer 107 and the release liner 106. A release layer 105 may be arranged between the adhesive layer 104 and the release liner 106.

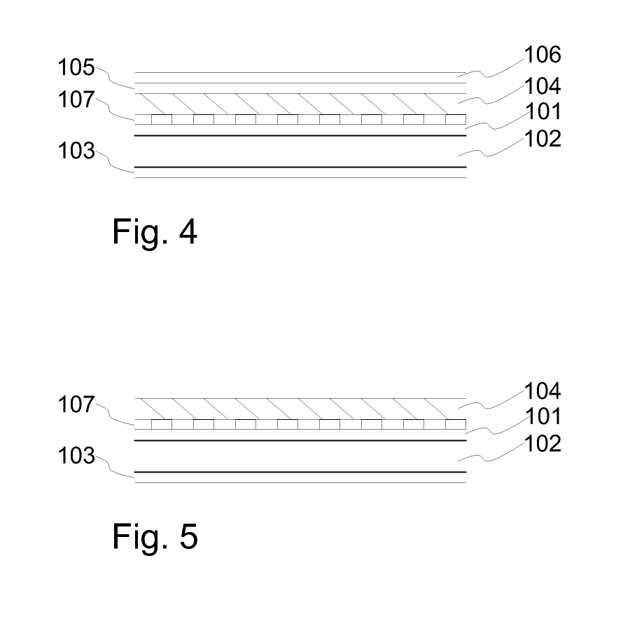

FIG. 4 illustrates a label according to an embodiment of the invention, wherein the adhesive layer 104, with the release liner 106, is attached on top of the printed layer 107. The integral unit including the adhesive layer 104 may be transferred after it's delamination to a correct position of the production line. The delaminated integral unit including the adhesive layer 104 may be directed and/or guided via rolls to a correct position and place in order to be applied on the printed surface 107. The integral unit including the adhesive layer 104 is underlying the integral unit including the face stock 102. The integral unit including the adhesive layer 104 is delaminated from the integral unit including the face stock 102. The integral unit including the adhesive layer 104 is transferred from a position underlying the integral unit including the face stock 102 to a position overlying the integral unit including the face stock 102. The integral unit including the adhesive layer 104 is guided to a correct position in a production line in order to be laminated to the integral unit including the face stock 102 such that the adhesive layer 104 is faced with the print layer 107. In the FIG. 4 the integral unit including the adhesive layer 104 has been delaminated to the integral unit including the face stock 102. After delamination the adhesive layer 104 is next to the print layer 107. The label of the FIG. 4 comprises a release layer 103, a face stock 102 overlying it, and optionally a top coat 101 overlying the face stock 102. A print layer 107 is overlying the top coat 101 in FIG. 4. The adhesive layer 104 is overlying the print layer 107, and a release liner 106 (with a release layer 105 in FIG. 4) is overlying the adhesive layer 104.

The adhesive layer 104 is arranged to over-coat the print layer 107. The adhesive layer 104 may have effect of making the construction durable. Printed inks are trapped between the face stock 102 and the adhesive layer 104. According to the embodiments there is no need to provide a separate coating on printed 107 face stock 102.

FIG. 5 illustrates a label according to an embodiment of the invention, wherein the release liner 106 is removed from the surface of the adhesive layer 104, which the adhesive layer 104 is laminated on the printed surface 107 of the face stock 102. The release liner 106 has been removed after the integral unit including the adhesive layer 104 has been delaminated with the integral unit including the face stock 102. The release liner 106 may be collected to a waste line. It is possible to collect the release liner 106 and recycle it. The collected release liner 106 may be returned to a recycling waste stream. Other applications may utilize the recycled release liner.

In FIG. 5 the release liner 106 is removed and the adhesive layer 104 is exposed. The adhesive layer now forms the uppermost layer of the label. The formed label is a linerless label. The adhesive remains attached to the label and provides an adhesive surface capable of adhering the label to the surface of an article during labelling. The adhesive layer 104 according to embodiments has effect of enabling attachment of the label(s) and/or providing self-adhesive label(s). When pressure sensitive adhesive, or alike is utilized, the adhering may be fast compared to, for example, curable adhesives. The adhesive layer 104 according to embodiments has effect of protecting the print layer 107. The adhesive layer 104 according to embodiments has effect of providing over-coat to a face stock 102 and/or to a print layer 107.

The label illustrated in FIG. 5 may be self-wound to a roll. Labe web is wound (rolled) in order to be storable and/or transferrable. The linerless printed label web may be transferred to a site, where the label web is stored and/or separate labels are formed and/or labels are attached on articles. When wound to a roll, the release layer 103 underlying the face stock 102 is arranged to act as a release layer for the adhesive layer 104 overlying the face stock 102. The adhesive layer 104 and the release layer 103 are next to each other, when the linerless label web according to FIG. 5 is wound onto itself. Embodiments have effect of providing a linerless, self-attachable label web, which is woundable onto itself.

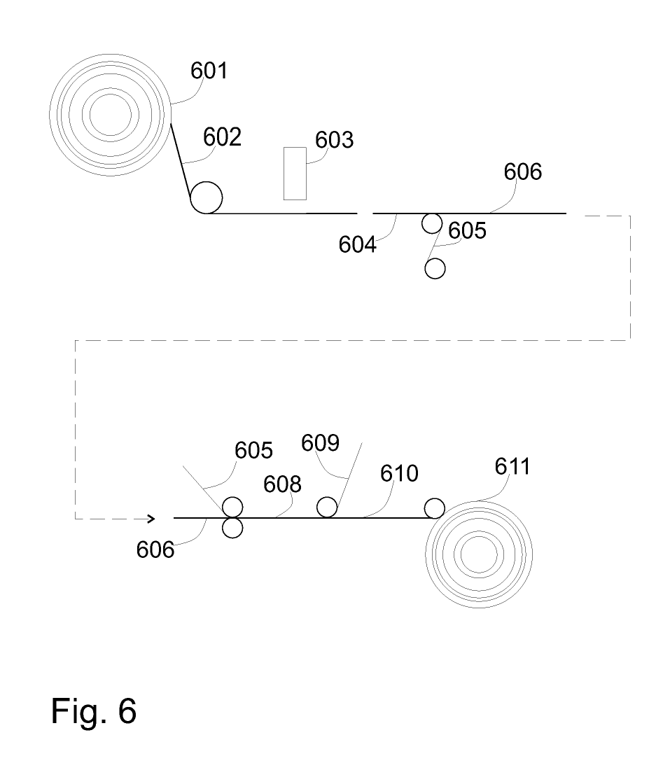

FIG. 6 illustrates an apparatus according to an embodiment of the invention. A roll 601 of label (stock), for example according to the FIG. 1, is provided. Top coat 101 of FIG. 1 is not a mandatory layer, but may be left out in some embodiments. Web of label 602 is unwind form the roll 601 and proceeded to a printer unit 603. The topmost layer of the label web is a printable layer. Before printing, the print layer may be surface treated. For example the print layer may be corona treated before actual printing. Corona treatment equipment, or other suitable surface treatment equipment may be situated before the printer unit 603. The printer unit 603 may be a matrix, laser or thermal transfer printing unit, for example. Printing methods may comprise flexographic, screen printing, offset, letterpress, or any other suitable printing methods compatible with the currently used label 602. Print is applied on the printable surface of a label web 602 at the printer unit 603. Printing is accomplished using a printer unit 603, like a printing press. An example of the printed label web 604 is illustrated in more detail in the FIG. 2.

After the label web has been printed 604, an integral unit including an adhesive layer 605 is delaminated from the integral unit including a face stock 606. A release liner may remain attached to the adhesive layer 605. In other words, the release liner is part of the integral unit including the adhesive layer 605. In an embodiment, the integral unit including the adhesive layer 605 is inverted in view of their original placement in the label (of FIG. 1) after the integral unit including the adhesive layer 605 has been separated from the printed face stock 606. The integral unit including the face stock 606, and having a print layer on it, runs along the original machine direction as a separate integral unit. According to an embodiment the integral unit including the adhesive layer 605 is turned around such that the delaminated adhesive layer, which is overlying the release liner, is after the turnaround arranged to overlie the release liner. According to an alternative embodiment the face stock comprising a print layer 606 is turned around. Turning around refers to change in web position, after which originally topmost layer becomes the lowest layer, and vice versa. A turn bar unit may be arranged to turn or invert one of the webs 605, 606 around. The turn bar unit may comprise roll(s), like a rewind roll. Turn bar unit may comprise crosswise arranged rolls, which on their turn enable turning the upmost surface of the web to become the lowest surface, and vice versa. The inverted or turned web comprises the layers of the original web in the inverted order. For example, the release liner 106 originally underlying the adhesive layer 104 is arranged to overlie the adhesive layer 104 after being inverted. Alternatively, the print layer 107 originally overlying the face stock 102 is arranged to underlie the face stock 102 after inverted. After one of the webs 605, 606 has been inverted it is possible to laminate the webs 605, 606 such that the print layer 107 and the adhesive layer 104 are laminated next to each other. Details of the delaminated integral units are shown in the FIG. 3.

According to an example embodiment the integral unit including the adhesive layer 605 is first delaminated from the the integral unit including the face stock 606. The face stock 606 continues running. The delaminated integral unit including the adhesive layer 605 is guided away from the face stock web 606, for example upwards from the face stock web 606. The integral unit including the adhesive layer 605 is guided via a first inclined roll, which is inclined approximately 45°. Thus the delaminated integral unit including the adhesive layer 605 is first guided upwards, approximately 90° from the web surface of the integral unit including the face stock 606, and then turned approximately 45° from the upwards direction to a side roll. The integral unit including the face stock 606 is rolled around said side roll in position of approximately 90° of the web direction of the face stock web 606. The integral unit including the adhesive layer 605 is arranged to make an U-turn around said side roll and return back to a second inclined roll, which inclined roll is inclined approximately 45°. The integral unit including the adhesive layer 605 proceeding via the second inclined roll is then guided back towards the web of the face stock web 606 in a turned position. The adhesive layer of the integral unit including the adhesive layer 605 is now facing the print layer of the integral unit including the face stock 606. The integral layer including the adhesive layer is laminated with the integral unit including the face stock such that the adhesive layer and the print layer are next to each other.

In the embodiment of the FIG. 6 the inverted integral unit including the adhesive layer 605 is directed onto the printed surface of the integral unit including the face stock 606. The adhesive layer is attached to the printed surface of the face stock. The integral unit including the adhesive layer 605 may be laminated on the integral unit including the face stock 606. In the FIG. 6 the adhesive layer 605 is laminated onto the printed surface of the face stock 606. This is done in a nip as shown in the FIG. 6. After this, the label 608 may correspond to the example label of FIG. 4. Next, the release liner overlying the adhesive layer is delaminated. The delaminated release liner 609 may be rewound in a web form. Alternatively it may be collected in other forms and/or means. Advantageously the release liner 609 is collected for further use. The recycled release liner may be used as a raw material for another object, for example. After the release liner 609 has been removed, the label web 610 corresponds to the example label presented in more details in the FIG. 5. After the release liner has been removed, the linerless label web may be self-wound to a roll 611. The roll 611 is then ready for storage, transfer and/or next process phase of labelling.

A linerless label may be self-wound to a roll 611, as shown in the FIG. 6. The construction of the label according to at least some/all embodiments enable rolling the self-attachable, linerless label web onto itself. The rolling is reversible process in a sense that the label roll shall be unwindable. The label roll is unwind in order to cut separate labels from the label web and/or provide self-attachable labels to an article. An adhesive layer of the label shall not attach to the layer next to it, when wound onto itself. In an embodiment used adhesive is active being in a sticking state constantly. For example pressure sensitive adhesive may be used. Light pressure may be enough to attach the label onto an article. According to embodiments, the layer next to the adhesive layer, when the label web is wound to a roll, is a release layer 103. The release layer is underlying or next to the unprinted surface of the face stock 102. A release layer underlying an unprinted surface of a face stock has effect of enabling wounding the self-attachable label web onto itself. The release layer wound next to the adhesive layer enables the label web to be releasably wound onto itself. The release layer underlying the face stock enables the self-adhesive label, comprising the adhesive layer overlying the face stock, to be self-wound. The release layer on one side of the face stock is arranged to form a release layer for the self-wound linerless label according to embodiments.

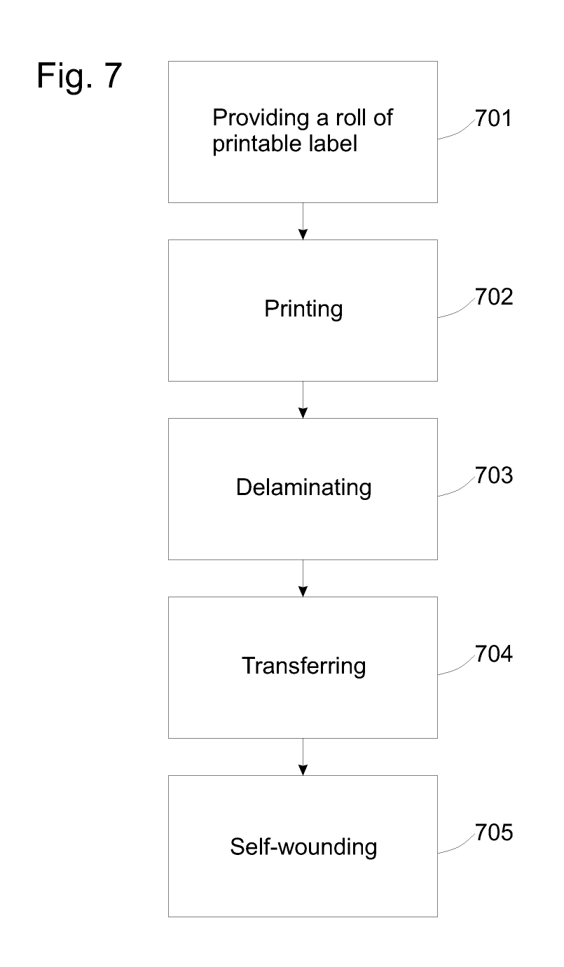

FIG. 7 illustrates a method according to an embodiment of the invention. Method comprises providing a roll of printable label 701. The label may be as illustrated in the FIG. 1. The method comprises printing the label 702. Typically a surface of the label is printed. The method may comprise a label having a coated top surface to be printable. The method may comprise treating the printable surface before printing. Topmost surface of the label may comprise a top coat and/or be treated in order to be printable and/or enable a good quality print. Different printing methods may be used. An example of a printed label is illustrated in more detail in the FIG. 2. Next, the method comprises delaminating 703 an integral unit including an adhesive layer from the printed face stock. The integral unit including the adhesive layer may comprise the adhesive layer and a release liner. Example of delaminated label parts are illustrated in the FIG. 3. The delaminated integral unit including the adhesive layer may be guided and/or transferred towards the printed surface of the face stock. The method may comprise a turning over the delaminated integral unit including the adhesive layer. A turning bar or several rolls may be used to implement turning. After the turning over the release liner, which is originally underlying the adhesive layer, is overlying the adhesive layer. The turned over adhesive layer and release liner may be directed to be attachable to the printed surface of the face stock. The delaminated integral unit including the adhesive layer is transferred on top of the web 704, onto the printed surface of the face stock. In an alternative embodiment, the integral unit including the face stock is turned over. After the turn over, the printed surface of the face stock, which is originally overlying the face stock, is underlying the face stock. After turning over either the integral unit including the adhesive layer, or the integral unit including the face stock, the adhesive layer is attached to the printed surface of the face stock. The integral units are laminated to each other. Before laminating, one of the integral units is turned 180° around the axis in the machine direction. An example of the label construction in this phase is illustrated in the FIG. 4. After this phase, the release liner may be removed. The release liner may be delaminated, for example as a waste web. The delaminated release liner may be collected for recycling. An example of the linerless label construction is illustrated in the FIG. 5.

The label, comprising a print layer ovelying a face stock and an adhesive layer overlying the printed layer, is self-wound. The topmost adhesive layer and the lowermost release layer are faced with and next to each other, when the label web is self-wound. The lowermost release layer forms a release layer for the topmost adhesive layer of the self-wound label.

A top coat may be left out from the previous embodiments. It is enough to provide printable surface with or without the top coat on the face stock.

An effect of the label according to embodiments is enabling laser or steel rule die cutting of the labels. Separate labels may be cut from the label web using laser, which is handy, fast and accurate. Another effect of the label according to embodiments is providing a linerless label. No release liner is needed for the printed label (stock) according to embodiments. An effect of embodiments is providing a linerless, self-attachable label web, which is woundable onto itself. Further effect of the label according to embodiments is enabling fast adhering of labels to the consumer products.

An effect of the embodiments is avoiding a separate coating phase. The printed surface does not need any separate layer, but an existing layer is used to form an overlying layer to the printed surface. This has effect of enabling printing and coating the printed surface at the same process phase.

According to embodiments no separate transferring of the printed label, nor separate coating units/stations are required. It is possible to transfer the existing adhesive layer with the existing equipment and/or at the same process phase. Conventionally printed label web may be transferred to a different site in order to provide a layer on top of the print layer. According to embodiments it is not necessary to wound and/or transfer the printed face stock for any further process. Instead an adhesive layer, which is part of the provided label stock, may be used. An embodiment has effect of enabling printing and over coating the print with the adhesive layer at the printing press.

At least some/all embodiments have effect of saving time and money. This may be due to lacking an extra layer and/or lacking extra process step, and/or lacking need to transfer the printed label web back to the label web provider. An effect of the embodiments is to finalize the printed surface and/or providing a label web ready for labelling process at one site.

Next numbered example embodiments of the invention are presented:

An embodiment 1 comprises a label comprising a face stock, an adhesive layer and a release liner, wherein the release liner is releasably attached to a surface of the adhesive layer and wherein an opposing surface of the adhesive layer is attached to a release layer, wherein the release layer is attached to a surface of the face stock, and wherein an opposing surface of the face stock comprises a printable surface; wherein the adhesive layer is detachable from the release layer attached to the surface of the face stock; and wherein the adhesive layer is attachable on a printable surface of the face stock.

An embodiment 2 comprise a label according to embodiment 1, wherein the adhesive layer and the release liner releasably attached to the surface of the adhesive layer are detachable form the release layer laminated to the surface of the face stock and attachable on the printable surface of the face stock.

An embodiment 3 comprises a label according to any of previous embodiments, wherein the adhesive layer is attachable on the printable surface of the face stock such that the adhesive layer is arranged next to the face stock.

An embodiment 4 comprises a label according to any of previous embodiments, wherein a further release layer is arranged between the release liner and the adhesive layer.

An embodiment 5 comprises a label according to any of previous embodiments, wherein the release layer and/or the further release layer comprises silicon.

An embodiment 6 comprises a label according to any of previous embodiments 4-5, wherein the release layer between the face stock and the adhesive layer comprises lower release value than the further release layer between the release liner and the adhesive layer.

An embodiment 7 comprises a label according to any of previous embodiments 5-6, wherein the release value of the release layer between the face stock and the adhesive layer in relation to the release value of the further release layer between the release liner and the adhesive layer is between 2.5:1-3.5:1, preferably 3:1.

An embodiment 8 comprises a label according to any of previous embodiments, wherein a top coat is arranged on the face stock, wherein the top coat is arranged to form the printable surface of the face stock.

An embodiment 9 comprises a label according to any of previous embodiments, wherein the face stock and/or the label is transparent.

An embodiment 10 comprises a label according to any of previous embodiments, wherein the face stock comprises at least one of polystyrene, polyester, polyolefin, polypropylene, polyethylene and polyethylene terephthalate.

An embodiment 11 comprises a label according to any of previous embodiments, wherein the face stock comprises thickness of 5-50 μm, preferably 10-30 μm.

An embodiment 12 comprises a label according to any of previous embodiments, wherein the label comprises thickness of 5-200 μm, preferably 25-100 μm.

An embodiment 13 comprises a label according to any of previous embodiments, wherein the release liner comprises at least one of polystyrene, polyester, polyolefin, polypropylene, polyethylene and polyethylene terephthalate.

An embodiment 14 comprises a label according to any of previous embodiments, wherein the release liner comprises a silicon release coating on a surface facing the adhesive layer.

An embodiment 15 comprises a label according to any of previous embodiments, wherein the face stock comprises a printed surface, and on the opposing surface a release layer.

An embodiment 16 comprises a label according to any of previous embodiments, wherein the delaminated adhesive layer is turnable and attachable on a printable surface of the face stock.

An embodiment 17 comprises a label according to any of previous embodiments, wherein the label is self-woundable.

An embodiment 18 comprises a label comprising a face stock, a print layer overlying the face stock, an adhesive layer underlying the face stock, wherein the adhesive layer is detachable from the face stock and attachable onto the print layer.

An embodiment 19 comprises a label according to embodiment 18, wherein the print layer is arranged to overlie a surface of the face stock, and the adhesive layer detached from the opposing surface of the face stock is attached onto the print layer.

An embodiment 20 comprises a label according to any of embodiments 18-19, wherein the detached adhesive layer is turned over.

An embodiment 21 comprises a label according to any of embodiments 18-20, comprising a release layer arranged to underlie the face stock and the adhesive layer arranged to overlie the face stock, wherein the release layer is arranged next to the adhesive layer on top of the printed surface of the face stock, when the label is self-wound to a roll.

An embodiment 22 comprises an apparatus comprising a roll arranged to unwind a wounded label stock, wherein the label stock comprises a face stock, an adhesive layer and a release liner, wherein the release liner is releasably attached to a surface of the adhesive layer and wherein an opposing surface of the adhesive layer is attached to a release layer, wherein the release layer is attached to a surface of the face stock, and wherein an opposing surface of the face stock comprises a printable surface; a printer unit arranged to print the printable surface of the face stock; a delaminate unit arranged to delaminate the adhesive layer from the release layer attached to the surface of the face stock, a laminate unit arranged to attach the delaminated adhesive layer on a printed surface of the face stock.

An embodiment 23 comprises an apparatus according to embodiment 22, wherein the delaminate unit is arranged to delaminate the adhesive layer with the release liner, and wherein the laminate unit is arranged to attach the adhesive layer with the release layer on the printed surface of the face stock.

An embodiment 24 comprises an apparatus according to any of embodiment 22-23, comprising a turn bar unit arranged to turn over the delaminated adhesive layer.

An embodiment 25 comprises an apparatus according to any of embodiments 22-24, wherein the delaminated adhesive layer is laminated on the printed surface of the face stock such that the adhesive layer is next to the printed surface.

An embodiment 26 comprises an apparatus according to any of embodiments 22-25, comprising a waste track arranged to remove the release liner from the adhesive layer laminated on the printed surface of the face stock.

An embodiment 27 comprises an apparatus according to any of embodiments 22-26, wherein a further release layer is arranged between the release liner and the adhesive layer; and/or wherein a top coat is arranged on top of the printable surface of the face stock.

An embodiment 28 comprises an apparatus according to any of embodiments 22-27, comprising a roll unit arranged to self-wound the label comprising the face stock, the adhesive layer on top of the printed surface of the face stock, and the release layer on the opposing surface of the face stock.

An embodiment 29 comprises a method for providing a self-wounded label stock, comprising providing a roll of printable label stock, wherein the label stock comprises a face stock, an adhesive layer and a release liner, wherein the release liner is releasably attached to a surface of the adhesive layer and wherein an opposing surface of the adhesive layer is attached to a release layer, wherein the release layer is attached to a surface of the face stock, and wherein an opposing surface of the face stock comprises a printable surface; printing the printable surface, detaching the adhesive layer from the release liner; and attaching the adhesive layer on a printed surface.

An embodiment 30 comprises a method according to embodiment 29, wherein the detaching the adhesive layer comprises detaching the adhesive layer and the release liner laminated thereto, and wherein the attaching the adhesive layer comprises attaching the adhesive layer and the release liner laminated thereto.

An embodiment 31 comprises a method according to any of embodiments 29-30, comprising transferring the adhesive layer detached from the release layer, to the printed side of the label.

An embodiment 32 comprises a method according to any of embodiments 29-31, comprising turning the detached adhesive layer in a turn bar before attaching.

An embodiment 33 comprises a method according to any of embodiments 29-32, wherein attaching the adhesive layer on a printed surface comprises laminating the adhesive layer and the printed surface next to each other.

An embodiment 34 comprises a method according to any of embodiments 29-33, comprising removing the release liner form the adhesive layer attached on the printed surface.

An embodiment 35 comprises a method according to any of embodiments 29-34, comprising a further release layer between the release liner and the adhesive layer.

An embodiment 36 comprises a method according to any of embodiments 29-35, comprising a top coat on a printable surface.

An embodiment 37 comprises a method according to any of embodiments 29-36, comprising self-wounding the label comprising the face stock, the adhesive layer overlying the printed surface of the face stock, and the release layer underlying on the opposing surface of the face stock.

It is obvious to a skilled person that modifications may be made to the illustrated embodiments. The invention is not limited to the detailed examples or embodiments presented in this application, but alternative solutions and other combinations are possible.

Word comprising may be used as an open term, but it also comprises the closed term “consisting of” throughout the application.

1. A label, comprising:
a face stock, an adhesive layer and a release liner,
wherein the release liner is releasably attached to a surface of the adhesive layer and wherein an opposing surface of the adhesive layer is attached to a release layer,
wherein the release layer is attached to a surface of the face stock, and wherein an opposing surface of the face stock comprises a printable surface;
wherein the adhesive layer is detachable from the release layer attached to the surface of the face stock; and
wherein the adhesive layer is attachable on a printable surface of the face stock.

2. The label according to claim 1, wherein the adhesive layer and the release liner releasably attached to the surface of the adhesive layer are detachable form the release layer laminated to the surface of the face stock and attachable on the printable surface of the face stock.

3. The label according to claim 1, wherein the adhesive layer is attachable on the printable surface of the face stock such that the adhesive layer is arranged next to the face stock.

4. The label according to claim 1, wherein a further release layer is arranged between the release liner and the adhesive layer.

5. (canceled)

6. The label according to claim 4, wherein the release layer between the face stock and the adhesive layer comprises lower release value than the further release layer between the release liner and the adhesive layer.

7. The label according to claim 6, wherein the release value of the release layer between the face stock and the adhesive layer in relation to the release value of the further release layer between the release liner and the adhesive layer is between 2.5:1-3.5:1.

8. The label according to claim 1, wherein a top coat is arranged on the face stock, wherein the top coat is arranged to form the printable surface of the face stock.

9. (canceled)

10. The label according to claim 1, wherein the face stock comprises at least one of polystyrene, polyester, polyolefin, polypropylene, polyethylene and polyethylene terephthalate.

11. (canceled)

12. (canceled)

13. The label according to claim 1, wherein the release liner comprises at least one of polystyrene, polyester, polyolefin, polypropylene, polyethylene and polyethylene terephthalate.

14. (canceled)

15. The label according to claim 1, wherein the face stock comprises a printed surface, and on the opposing surface a release layer.

16. The label according to claim 1, wherein the delaminated adhesive layer is turnable and attachable on a printable surface of the face stock.

17. The label according to claim 1, wherein the label is self-woundable.

18. The label comprising:
a face stock,
a print layer overlying the face stock,
an adhesive layer underlying the face stock,
wherein the adhesive layer is detachable from the face stock and attachable onto the print layer.

19. The label according to claim 18, wherein the print layer is arranged to overlie a surface of the face stock, and the adhesive layer detached from the opposing surface of the face stock is attached onto the print layer.

20. The label according to claim 18, wherein the detached adhesive layer is turned over.

21. The label according to claim 18, further comprising:
a release layer arranged to underlie the face stock and the adhesive layer arranged to overlie the face stock, wherein the release layer is arranged next to the adhesive layer on top of the printed surface of the face stock, when the label is self-wound to a roll.

22. An apparatus, comprising:
a roll arranged to unwind a wounded label stock, wherein the label stock comprises a face stock, an adhesive layer and a release liner, wherein the release liner is releasably attached to a surface of the adhesive layer and wherein an opposing surface of the adhesive layer is attached to a release layer, wherein the release layer is attached to a surface of the face stock, and wherein an opposing surface of the face stock comprises a printable surface; a printer unit arranged to print the printable surface of the face stock; a delaminate unit arranged to delaminate the adhesive layer from the release layer attached to the surface of the face stock, a laminate unit arranged to attach the delaminated adhesive layer on a printed surface of the face stock.

23. (canceled)

24. The apparatus according to claim 22, further comprising:
a turn bar unit arranged to turn over the delaminated adhesive layer.

25. The apparatus according to claim 22, wherein the delaminated adhesive layer is laminated on the printed surface of the face stock such that the adhesive layer is next to the printed surface.

26. (canceled)

27. (canceled)

28. The apparatus according to claim 22, further comprising:
a roll unit arranged to self-wound the label comprising the face stock, the adhesive layer on top of the printed surface of the face stock, and the release layer on the opposing surface of the face stock.

29-37. (canceled)

38. The label according to claim 7, wherein the release value of the release layer between the face stock and the adhesive layer in relation to the release value of the further release layer between the release liner and the adhesive layer is 3:1.
